(19) United States
(12) Patent Application Publication
(10) Pub. No.: US 2005/0127211 A1
(43) Pub. Date: Jun. 16, 2005

(54) METHOD AND ASSEMBLY FOR CONVERSION OF A STANDARD SHOWERHEAD TO A SPRAY BAR

(76) Inventor: John O. Yeiser, Alpine, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 10/711,946

(22) Filed: Oct. 14, 2004

Related U.S. Application Data
(60) Provisional application No. 60/511,184, filed on Oct. 14, 2003.

(51) Int. Cl. B05B 15/06

(52) U.S. Cl. 239/587.1; 239/436

(57) ABSTRACT

The method and assembly are provided for converting a standard showerhead into a combination showerhead and spa spray bar that can be easily installed without modification of existing house plumbing. The spray bar comprises a cylindrical tube with a series of small bores adapted to project individual streams of water perpendicular to the surface of the tube with sufficient pressure to produce a soothing or stimulating effect when they contact the bather's skin. After removal of the existing showerhead, a 3-way connector is connected to the existing water source for directing water to both the showerhead and the spray bar. Flow control valves permit selection one or both of the showerhead and spray bar. The spray bar is attached to a vertical surface located near the bathing position so that multiple water streams are projected towards the user's bathing position.

### CROSS-REFERENCE TO RELATED APPLICATIONS

This application is the utility filing of U.S. provisional patent application Ser. No. 60/511,184, filed Oct. 14, 2003, which is incorporated herein by reference in its entirety.

### STATEMENT REGARDING FEDERALLY SPONSORED RESEARCH OR DEVELOPMENT

None.

### BACKGROUND OF THE INVENTION

Shower installations have traditionally been accomplished by extending a vertical pipe or tube upward from a shower tap to shower height where it is connected to a drop ear 90 degree elbow fitting with 1/2 inch female N.P.T. (“National Pipe Thread”) threads which faces toward the shower room ready to receive a male threaded shower arm in the final stage of construction, connecting the elbow to a showerhead. The elbow is nailed or screwed securely to a plate positioned within a stud wall which will be closed off with the finished wall. A length of threaded test pipe is then threaded into the elbow. The material used for the test pipe is often the most inexpensive, such as uncoated, black steel pipe. Test pipes made of such material are commonly discarded after one use. Uncoated pipe can rust, which causes further problems, as detailed below. The test pipe is then capped and the system is pressure tested. After the plumbing system is pressure tested, a finish wall covering material, such as wallboard, is applied with a hole cut to accommodate the test pipe and the wall is finished with tile, paint, wall paper, etc. Once the pressure test is complete and the finished wall is in place, the test pipe is removed and a shower arm (i.e. commonly a 6″ to 8″ length of pipe threaded ½″ N.P.T. at both ends and bent roughly 45 degrees in the middle) is installed by threading it into the 90 degree elbow which is now hidden inside of the finished wall. It is important that the joint between the shower arm and the supply line does not leak yet the joint cannot be readily tested without cutting into the wall. An escutcheon plate is slid over the shower arm to cover the hole through which the shower arm extends. A showerhead can then be installed onto the shower arm.

Tub spout installations are typically accomplished using one of two standard methods. The first is similar to the above-mentioned traditional method for showerhead installation where a drop of 90 degree elbow fitting is securely fastened behind the finished wall at the precise level for the tub spout connection. Black iron test nipples are stubbed out, then extracted and a precise length of a supply line with male threaded nipples on each end is installed blindly onto the elbow fitting enclosed in the finished wall. The tub spout is then threaded directly onto the open end of the supply line. In another, more recently developed tub spout installation method, copper or other rigid tubing (⅝″ O.D.) is stubbed out of the wall and specially designed and compression type tub spouts, which are expensive, are slid over the tube and secured by means of an integral clamp or set screw built into the spout's housing.

The traditional shower installation method presents a number of potential problems. The drop-ear elbows are fairly expensive and, often, will be inadequately secured to the plate behind the wall. As the threaded test pipe must be extracted and a threaded shower arm be reinstalled into the elbow, the elbow undergoes several occurrences of significant leverage and torque. First, the threads of the test pipe often become seized or rusted after a water pressure test is performed, causing excessive stress on the mounting anchors of the elbow as the test pipe is unthreaded. Secondly, additional stress is applied to the anchors of the elbow as the shower arm is often over tightened in order to orient it in an exact downward direction on the finished or showerhead end. It, therefore, becomes extremely important to secure the elbow as solidly as possible. Craftsmen often go to great length to assure the solid security of the elbow, using one or more wood or metal brackets and braces and screws and nails of significant quantity and size. If the elbow is improperly secured, a variety of problems can ensue, ranging from misalignment of the female threads relative to the hole in the wall, making the shower arm installation difficult or impossible, or kinking and possibly severing the supply pipe. Even when the 90 degree elbow is properly installed and properly located behind the hole, the test pipe may have been cross threaded or over tightened into the elbow, thus damaging the female threads of the elbow. The test pipe may then pass the pressure test, but, when it is removed and the shower arm installed into the damaged threads of the elbow, a slow leak can result. Since the elbow is totally hidden within the wall, the leak can continue for years without being detected, often causing rot and mildew to occur within the wall and/or in the wall bottom plate, with consequent odor and hidden damage. Also, as there may be rusty, residual water in the test pipe, it may spill onto finished tub/shower surfaces when the test pipe is extracted, permanently staining such surfaces and only remedied by total replacement, with the attendant labor and material expense and delays. Also, since the shower arm must be positioned at a predetermined orientation to accommodate the showerhead, it must be threaded into the elbow until it reaches that orientation. This can result in under tightening or over tightening of the arm to achieve that orientation, which can also result in leaks. Finally, after a shower arm has been in place for a number of years, it may corrode behind the finished wall and leak or even break off, leaving a threaded portion in the elbow. Repair of any of these problems necessitates cutting into the finished wall either on the shower side or from behind the shower wall, with the attendant labor, expense and down time associated therewith.

Several devices for converting a faucet into a movable and extendable showerhead are known in the art. For example, U.S. Pat. No. 1,279,006, issued to Rose, discloses a device that can be readily applied to or detached from a standard bathtub fixture which affords a full and effective shower. The device includes a flexible tube adapted to connect to a bathtub faucet on one end and a showerhead on the other. Straps are placed around both ends of the flexible hose and secured to the faucet and showerhead, respectively, by screws and thumb nuts. A rigid arm separates the bands and functions to mount the showerhead in different positions. The bands, straps, and all other parts, except for the flexible tube, are made of sheet metal.

U.S. Pat. No. 5,014,919, issued to Knapp, describes a hand-held showerhead for domestic sinks having a tubular handle member connected to the water supply via flexible piping. Although this patent does not describe means for connecting the flexible pipe to a water supply, this patent reference does disclose a hand-held showerhead that can be used with a faucet and residential sink that is adapted for low supply water pressure and particularly for a water supply through a simplified diverter valve.

Further, U.S. Pat. No. 4,413,362, issued to Chianco et al., discloses a sit-down shower for children which includes a sleeve adaptor that fits over a bathtub's tap and a rigid and self-supporting tubing extending from the adapter which projects the shower water to a movable showerhead that is connected to the far end of the rigid tubing. The rigid tube forms a one-piece plastic molded unit with the adaptor and the adaptor may be clamped on the faucet with a conventional clamp.

U.S. Pat. No. 6,315,220 issued to Grubb, discloses a method and apparatus for converting a faucet or existing showerhead into a flexible and extendible shower apparatus. However, this patent discloses an adapter that requires the sacrifice of an existing shower or faucet to provide another shower or faucet.

It is further known in the art to have more than one showerhead attached to a single primary water source. The multiple head shower devices of this paradigm are analogous to a multi-headed hydra, having a single neck and body. Although there are potentially more than one head, the water cannot be directed in more than one direction, e.g., either directed up, or down, not both. There is generally minimal physical separation between the spray heads whereby they function more like a single, large, spray head, then different individual spray heads.

A number of vertical type showers, frequently referred to as “rainbars”, are commercially available. Connecting the vertical type shower currently requires expert plumbing and often remodeling or other construction work, including tearing out and replacing tile work or other shower wall surface. Those units use a cylindrical tube with multiple water outlets placed parallel to and along the length of the tube, thereby providing a vertically oriented shower of water. However, these units are connected to the user's shower via 90-degree fixed pipe fittings and/or through parallel connection to the water supply through the shower wall. These fittings must be mounted through the shower wall and connected to plumbing behind the structural shower wall. The demolition and repair required for such installations has limited their applications to only those remodeling a shower or building a custom shower. Accordingly, the need remains for an apparatus and method for connecting to an existing showerhead to create a second shower output channel, such as a vertical type shower, without sacrificing operation of the first showerhead and without extensive and costly re-plumbing of shower water inlets.

### BRIEF SUMMARY OF THE INVENTION

The present method and assembly are directed to converting a standard showerhead into a combination showerhead and spray bar that can be easily installed without modification of existing house plumbing. In an exemplary embodiment, the spray bar comprises a cylindrical tube approximately 1/2 to ¾″ (12-20 mm) outer diameter with a series of small bores drilled into the tube parallel with the length of the tube. The tube may be formed from aluminum, steel, hard plastic or other appropriate material. The bores are adapted to project individual horizontal streams of water perpendicular to the surface of the tube. In the exemplary embodiment, a nipple or nozzle is disposed in each bore to assist in focusing the spray and increasing back pressure so that the streams have sufficient pressure to produce a soothing or stimulating effect when they contact the bather's skin. These nozzles may be formed from any suitable polymer, metal, e.g., brass, stainless steel, aluminum, or other appropriate material. When mounted in a vertical orientation, the spray bar produces streams of water that impinge along the length of the user's body, thus providing better body coverage than a standard showerhead that only directs water in a downward direction toward the user's head, neck and/or shoulders. The spray bar is not limited to a linear configuration, but may be formed with alternative shapes, including different curved shapes. The addition of the spray bar of the present invention to an existing showerhead allows the user to select the overhead shower, the spray bar, or a combination of both.

The spray bar, although labeled a “bar”, is not limited to a linear arrangement of spray nozzles. The spray nozzles may be staggered along a center line, or the spray bar can be configured with curves or bends, such as a “S”, “C” or “U” shape. In the preferred embodiment, the tube has a circular cross-section and is of cylindrical form for ease of manufacture and ease of installation.

In an alternative embodiment, the spray bar may be configured with a telescoping structure, wherein the length of the bar can be expanded or contracted. This facilitates packaging of the conversion kit for sale, but also permits the user to vary the length of the spray bar during use. In this embodiment, it may be desirable to include flexible seals to minimize leakage between the telescoping segments. Alternatively, the bar can have one or more swivel joints disposed along its length to allow the bar to be folded into smaller segments, which also provide the user the ability to varying the spray pattern from the bar.

The shower converter assembly is connected to existing plumbing as is present in most standard showers. By removing the existing showerhead from the water outlet pipe and screwing on a 3-way (“T” or “Y” connector), the existing showerhead can be mounted back to one of the two remaining outlets on the 3-way connector and then the spray bar may be attached to the last remaining output connection. This allows the shower conversion kit to be installed in minutes without requiring modification of the existing plumbing or surrounding structures and without sacrificing one showerhead to provide another shower device.

A first flow control valve may be integrated into the 3-way connector or added between the first outlet of the 3-way connector and the existing showerhead, allowing water flow control and/or differentiation of flow to the spray bar and/or the showerhead. In this embodiment, the user is able to turn off the shower, but keep water flowing to the spray bar. A second flow control valve can be integrated into the second outlet of the 3-way connector or inserted between the second outlet and the spray bar allowing the user to turn off or adjust the pressure from the spray bar independent of the pressure to the showerhead.

In one embodiment, the connection between the spray bar converter and the second outlet of the 3-way connector is a flexible hose. The spray bar is then mounted or secured to the shower wall or other vertical surface.

In another embodiment, the spray bar is connected to the 3-way connector using rigid tubing. The tubes are connected to the 3-way connector via a threaded connection, or alternate watertight means. The preferred embodiment utilizes two tubes that are connected to each other via a pivot elbow joint, facilitating re-positioning of the spray bar as desired. The rigid tubing with the pivot elbow joints acts like a pantograph.

In the exemplary embodiment, the spray bar is held in place by a mounting bracket having a wall mounting means; such as a screw, an adhesive, a suction means or friction enhancing means. Alternatively, the spray bar can be injection molded with means for fastening mounting devices such as suction cups or adhesive tape, or mounting hardware can be pre-affixed to the spray bar, such that separate mounting brackets are not required. In the preferred embodiment, a mounting bracket comprising a C-shaped clamp with at least partially resilient sides is used. The clamp has an inner curvature that closely fits the outer surface of the spray bar, so that the spray bar snaps into the clamp and is held in place by an interference fit. The clamp may alternatively have an open hinged, spring-biased configuration adapted to close partially or fully around the outer surface of the spray bar after placement of the spray bar against the back portion of the clamp. In another alternative embodiment, the clamp may further be an elastic type securing device, which elastically secures the cylindrical tube of the spray bar. Yet another alternative mounting means is a hanger or hanging clamp for suspending the spray bar from the water source tube that extends from the shower wall.

### BRIEF DESCRIPTION OF THE SEVERAL VIEWS OF THE DRAWING

Understanding of the present invention will be facilitated by consideration of the following detailed description of a preferred embodiment of the present invention taken in conjunction with the accompanying drawings, in which like numerals refer to like parts.

FIG. 1 is a diagram showing the individual components used for installation of the shower converter of the present invention.

FIG. 2 is a diagram showing an embodiment of the shower converter with a flexible hose connection and flow control valves.

FIG. 3 is an exploded view of the suction cup based securing bracket according to the present invention.

FIG. 4 is an exploded view of the two-sided tape based securing bracket according to the present invention.

FIG. 5 is an exploded view of the permanent securing bracket according to the present invention.

FIG. 6 is a diagrammatic view of a telescoping embodiment of the spray bar.

FIG. 7 is a diagrammatic view of a folding embodiment of the spray bar.

### DETAILED DESCRIPTION OF THE INVENTION

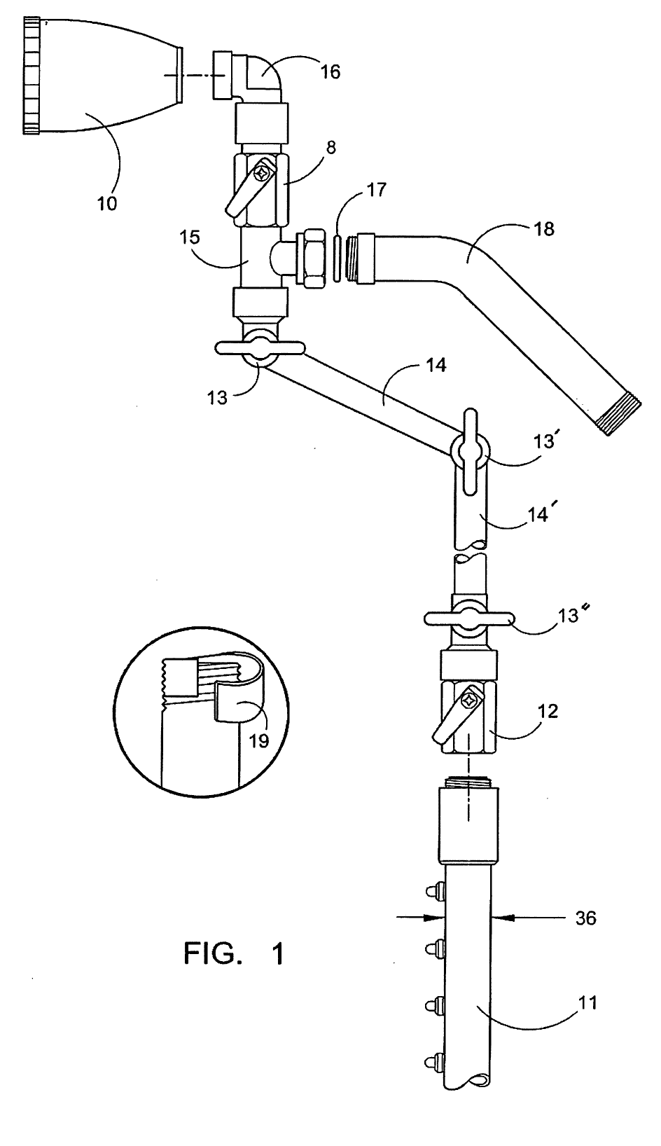

The assembly for retrofitting an existing showerhead installation with a combination showerhead and spray bar is illustrated in FIG. 1. The components described below that are not part of the pre-existing plumbing are part of the conversion kit for creating the combination showerhead and spray bar.

The spa spray bar 11 is generally a cylindrical tube having an outer diameter on the order of 12-20 mm (½″-¾″) that produces a plurality of streams of water through multiple spray nozzles 6 mounted within bores formed along the length of the tubing. The tube may be formed from aluminum, steel, hard plastic or other appropriate material. The nozzles 6 are adapted to project individual horizontal streams of water perpendicular to the surface of the tube. The nozzles 6, which may be formed from any suitable polymer, metal, e.g., brass, stainless steel, aluminum, or other appropriate material, have a sufficiently small inner diameter to generate back pressure so that the resulting streams of water provide a massaging (soothing or stimulating) sensation for the user. While in the preferred embodiment the nozzles 6 are arranged in a line, the mounting positions of the nozzles 6 need not be perfectly linear. For example, the nozzles 6 may be slightly offset from a centerline in a staggered arrangement, as long as the spray pattern is projected outward toward the showering or bathing position, i.e., where a bather stands within the shower enclosure. Furthermore, the spa spray bar 11 need not be linear, but may be curved, e.g., in a “C”, “U”, “Z” or “S”, or any other shape that is capable of providing a desirable spray pattern, including closed geometric shapes.

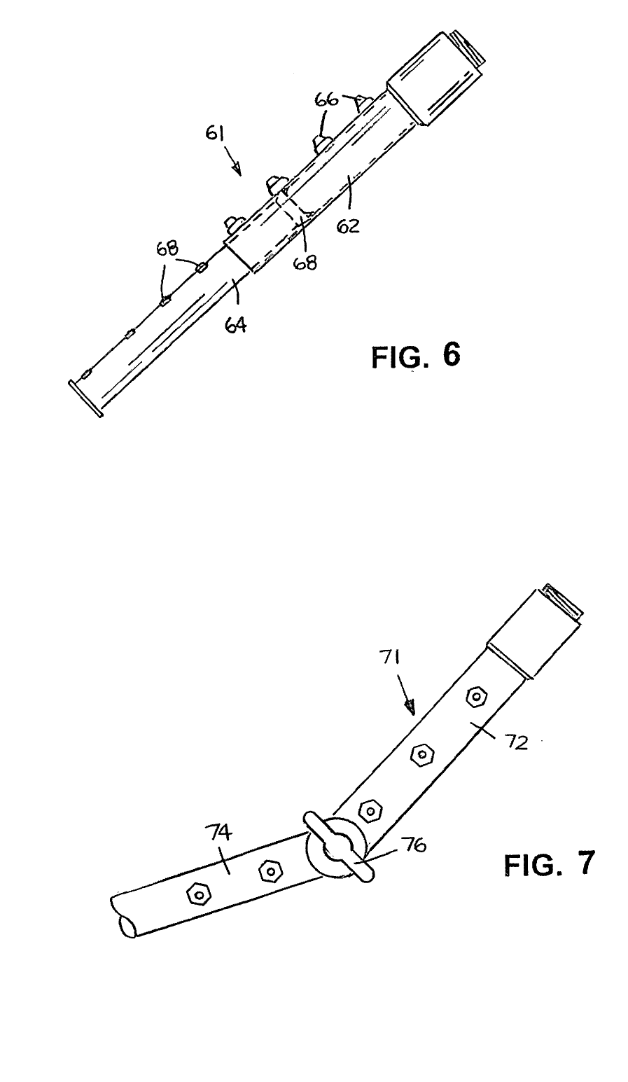

In an alternative embodiment of the spray bar illustrated in FIG. 6, spray bar 61 may be configured with a telescoping structure, wherein the length of the bar can be expanded or contracted. This facilitates packaging of a conversion kit for retail sale and for shipping, but also permits the user to vary the length of the spray bar during use. As illustrated, lower section 64 fits slideably within upper section 62, however, a reverse arrangement in which the lower section is the larger tube can also be used. In this embodiment, it may be desirable to include a flexible seal 68 that fits closely within the inner diameter of the larger diameter section to minimize leakage between the telescoping segments. Also, as will be readily apparent, while nozzles 66 can be disposed within the upper section 62, placement of similar nozzles within lower section 64 will prevent sliding of lower section 64 into section 62. In this case, bores without nozzles, or smaller nozzles 68 that project only slightly from the outer surface will be inserted into the bores located in the smaller diameter, i.e., nesting, section. Smaller nozzles 68 can be formed from polymer, such as Teflon®, brass, or other appropriate material.

In another alternative embodiment of the spray bar illustrated in FIG. 7, spray bar 71 can have one or more flexible joints 76 disposed along its length to allow the bar to be folded into smaller segments. As shown, upper section 72 is joined to lower section 74 by swivel joint 76. Additional sections and swivel joints may be used for greater flexibility and compactness. In addition to facilitating packaging of the conversion kit for sale, this provides the user the ability to vary the spray pattern from the bar.

In a first embodiment, the spa spray bar 11 is mounted on the pre-existing source pipe 18 that extends from the shower wall after removal of the existing showerhead. A standard showerhead 10, such as the one that was previously attached to source pipe 18, is connected through a pipe joint 16 to upper flow control valve 8 to the first outlet of a “T” connector 15. Pipe joint 16 is illustrated as a 90° connection, however, different lengths and angles may be used to achieve the desired orientation for the showerhead 10. Upper flow control valve 8, which is optional, can be adjusted to be fully opened, fully closed or partially open for reduced flow, controls water flow to showerhead 10. For example, if the user wishes to shower without getting his or her hair west, upper flow control valve 8 would be closed, and all of the water would be diverted to spray bar 11. In an alternative embodiment, upper flow control valve 8 can be integrated into the first outlet of “T” connector 15. The inlet end of “T” connector 15 is mounted onto the source pipe 18, typically using a threaded attachment. An “O” ring 17 may be provided to prevent or minimize leakage. The second outlet of the “T” joint 15 is connected through an optional swivel joint 13 to straight pipe connector 14. Straight pipe connector 14 is further optionally connected to another swivel joint 13′, which is further connected to another connector pipe 14′. Connector pipe 14′ is further optionally connected to swivel joint 13″, if needed, to provide the desired height and orientation of the spray bar 11. A lower flow control valve 12 is connected to the inlet of the spray bar 11 to control water flow to the spray bar. As with the upper flow control valve 8, lower flow control valve 12 is optional and can be adjusted to be fully opened, fully closed or partially open for reduced flow. This permits the user to adjust the water spray pressure to his or her individual preference. Where needed, plumber's tape 19, e.g., Teflon® tape, can be applied to the threads of each male set of pipe threads used to connect the various pipes to ensure a good seal. It should be noted that showerhead 10 is not limited to the configuration illustrated and that other styles of showerheads, including overhead showers, may be used with the present invention. Additional plumbing may be required so that the showerhead is positioned appropriately to reach the bathing position.

The present invention is also applicable where the main water supply line is other than a pre-existing shower fixture extending from a shower wall. For example, the invention may be utilized with a standard faucet such as in a tub or with an electrically-heated shower unit. As shown in FIG. 2, the second embodiment includes “T” connector 15, which is connected through first flow control valve 8 which is connected to the connector pipe 14, which may be either flexible or solid tubing. Note that first flow control valve 8 is optional and should not be used with electrically-heated shower units. Connector pipe 14 is connected to optional second flow control valve 12, which is connected to the spray bar 11. The spray bar 11 is affixed to a vertical surface, which can be a shower wall, the wall next to a tub, or to the side of the tub, by one or more mounting brackets 20. While vertical orientation may be preferable for use in a shower, the spray bar 11 need not be mounted in a vertical orientation. For example, the spray bar may be mounted in a horizontal orientation on the side of a bathtub. With the use of a four way connector or an additional 3-way connector, two or more spray bars can be installed on different sides of the shower or the bathtub to surround the user with streams of water.

In either of the embodiments of FIGS. 1 and 2, second flow control valve 12 can be integrated with any one of the second outlet of 3-way connector 15, connector pipes 14 or the inlet end of spray bar 11.

To ensure that the water stream stay directed toward the bathing position, embodiment, the spray bar 11 can held in place by a wall mounting means such as a screw, an adhesive, a suction means or friction enhancing means. In one embodiment, the spray bar can be formed, e.g., by injection molding, with integral bosses or tabs formed on the outer surface for affixing mounting devices such as suction cups or adhesive tape. In another alternative mounting means, mounting hardware can be pre-affixed to the spray bar, such that separate mounting brackets are not required. Yet another mounting means that can be used is a hanger or hanging clamp that can be used to suspend the spray bar from source pipe 18 so that the spray bar is held in position adjacent the shower wall under the source pipe. In the preferred embodiment, one or more mounting brackets 20 are used to hold the spray bar 11 in place on the vertical surface.

Each mounting bracket 20 includes a “C” shaped clamp 21 adapted to firmly retain the spray device 11. The base of the “C” shaped clamp 21 has an inner diameter that closely fits the outer diameter 36 of the spray bar 11, while the distance between the inward extensions of the sides 22 of the clamp 21 is smaller than the outside diameter 36. The “C” shaped clamp 21 is made of an elastic, yet strong and sturdy material such that, upon application of sufficient pressure by the cylindrical pipe of the spray bar 11, the sides 22 are resiliently spread apart to allow the spray bar 11 to slide toward the base of the “C” shaped clamp 21, so that it is held firmly in place, as shown in FIG. 2.

FIG. 3 depicts one embodiment of the mounting bracket 20 having a suction cup 25 means for shower wall attachment. The suction cup 25 attaches via a bolt 24, through a hole in bracket 20 where a knob 23 is adapted with corresponding threads to engage the bolt 24 of the suction cup 25.

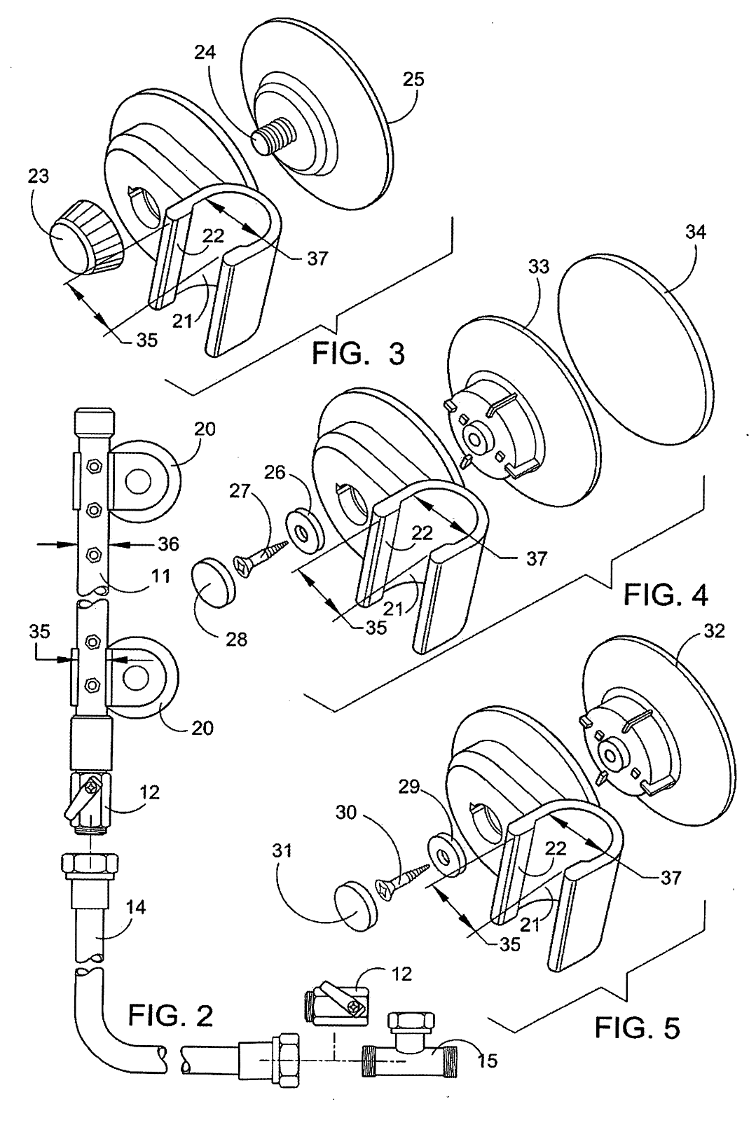

The securing bracket 20 may be attached to the vertical wall according to various attachment means. In the embodiment of FIG. 4, the bracket 20 is depicted as removably adhering to the shower wall via double sided tape 34, an example of a gluing attachment means. The double sided tape 34 is adhered to a spacer 33 having means whereby it is securely attached to the securing bracket 20, perhaps by a short screw or bolt 27 and a washer 26. The screw or bolt 27 may be optionally hidden from view through the use of a plug 28 to fill in the hole used to secure the bracket 20 to the spacer 33 and the double sided tape 34.

The securing bracket may further be permanently attached to the shower wall through the use of a more permanent means of attachment, such as a longer screw or bolt 30. This long screw or bolt 30 is also placed through a washer 29 of suitable material, such as metal, rubber or plastic, and placed through a hole in the securing bracket 20 and an optional spacer 32 of suitable material and dimensions whereby the bracket is securely attached to the shower wall.

The bracket 20 is described and shown where the “C” type clamp 21 is positioned off-center relative to the means for attaching the bracket to the shower wall 25. Although not depicted in the various figures, in an embodiment, the “C” type clamp 21 can alternatively be centered relative to the means for attaching the bracket to the shower wall.

The term “spray bar” shall be understood to mean an elongated, tubular, multi-nozzle, shower device, which is preferably installed on a vertical surface, so that water streams are emitted perpendicular the vertical surface.

The term “water flow-directing” joint shall be understood to mean a 3-way joint, which can be a “T” or a “Y” joint, as is known by those of skill in the art of plumbing.

A flow control valve, such as valves 8 and 12 of FIG. 2, is a valve that is capable of adjustably controlling the flow rate, including preventing flow, through the associated pipe. This type of valve is known in the related art of plumbing. The flow control valves need not be separate components, but can be incorporated in other connectors in the conversion kit or in the spray bar itself.

Attachment means shall include suction-cup, adhesive, including two-sided tape and more permanent means, such as screw or nail. Although the figures illustrate suction-cup, two sided tape and screw means for attaching the securing bracket and gripping hand to the wall, it will be readily apparent to those in the art that other attachment means may be used for securely attaching the securing bracket to the wall.

The term “connecting” shall include the connection of two pipes in a manner such that fluid may pass between them. In a typical plumbing paradigm, two pipes are connected such that the lumen are in fluid communication with each other, and potentially with other members of the fluid system. In these systems, fluid, such as water, passes from the output of one pipe to the input lumen, or input portion of another, connected pipe.

All other terms used herein are known in the related art of plumbing and are used accordingly.

The method and assembly of the present invention provide the ability to easily install a spa-like shower fixture without requiring extensive plumbing modification and without tearing out the shower wall to access the built-in plumbing installation for modification. The optional flow controllers of the combination showerhead and spray bar permit the user to select a combination of shower and spray bar, or to select either the shower or spray bar. The optional swivel joints permit the user to adjust the height of the spray bar.

Other embodiments and modifications of the present invention will occur readily to those of ordinary skill in the art in view of these teachings. Therefore, this invention is to be limited only by the following claims which include all such other embodiments and modifications when viewed in conjunction with the above specification and accompanying drawings.

1. A method for converting a shower to a combination shower and spray bar, the method comprising:
removing an existing showerhead from a water supply outlet;
attaching an inlet of a 3-way connector to the water supply outlet, wherein the 3-way connector has a first outlet and a second outlet;
connecting a showerhead to the first outlet of the 3-way connector;
connecting a spray bar to the second outlet of the 3-way connector, wherein the spray bar comprises a plurality of spray nozzles for projecting a plurality of water streams toward a bathing position; and
securing the spray bar on or adjacent a vertical surface near the bathing position.

2. The method according to claim 1, wherein the step of securing comprises retaining the spa spray bar within a clamp adapted for receiving an outer diameter of the spray bar.

3. The method according to claim 2, wherein the clamp is attached to the wall by suction, adhesive or permanent attachment means.

4. The method according to claim 1, further comprising inserting a flow control valve between the water supply outlet and the showerhead.

5. The method according to claim 4, wherein the flow control valve is incorporated into the first outlet of the 3-way connector

6. The method according to claim 1, further comprising inserting a flow control valve between the second outlet of the 3-way connector and the spray bar.

7. The method according to claim 1, further comprising inserting one or more swivel joints between the second outlet of the 3-way connector and the spray bar.

8. The method according to claim 1, wherein the spray bar comprises a plurality of telescoping sections.

9. The method according to claim 1, wherein the spray bar comprises a plurality of sections connected by one or more swivel joints.

10. An assembly kit for converting an existing showerhead on a pre-existing water source outlet into a combination showerhead and spray bar, the assembly comprising:
a 3-way connector for mounting on the water source outlet after removal of the existing showerhead, the 3-way connector having a first outlet and a second outlet;
a pipe joint for connecting the first outlet to a showerhead;
at least one connector pipe connected to the second outlet of the 3-way connector, the at least one connector pipe having an outlet end;
a spray bar connected to the outlet end of the at least one connector pipe, the spray bar having a plurality of nozzles adapted to produce a plurality of water streams projected toward a bathing position; and
at least one mounting device for affixing the spray bar on or adjacent a vertical surface near the bathing position.

11. The assembly according to claim 10, wherein the mounting device comprises a clamp adapted for receiving an outer diameter of the spray bar and a fastening means.

12. The assembly according to claim 11 wherein the fastening means comprises a suction cup or an adhesive.

13. The assembly according to claim 10, wherein the at least one connector pipe comprises a first connector pipe and a second connector pipe and further comprising a swivel joint disposed between each of the second outlet of the 3-way connector and the first connector pipe, the first connector pipe and the second connector pipe, and the second connector pipe and the spray bar.

14. The assembly according to claim 10, further comprising a flow control valve disposed between the at least one connector pipe and the spray bar.

15. The assembly according to claim 10, further comprising a flow control valve disposed between the first outlet of the 3-way connector and the pipe joint.

16. The assembly according to claim 10, wherein the spray bar comprises a plurality of telescoping sections.

17. The assembly according to claim 10, wherein the spray bar comprises a plurality of sections connected by one or more swivel joints.

18. An assembly for converting an existing showerhead on a pre-existing water source outlet into a combination showerhead and spray bar, the assembly comprising:
a 3-way connector for mounting on the water source outlet after removal of the existing showerhead, the 3-way connector having a first outlet and a second outlet;
a pipe joint for connecting the first outlet to a showerhead;
a first flow control valve disposed between the first outlet of the 3-way connector and the pipe joint;
at least one connector pipe connected to the second outlet of the 3-way connector, the at least one connector pipe having an outlet end;
at least one swivel joint disposed between the second outlet of the 3-way connector and the outlet end of the at least connector pipe;
a spray bar connected to the outlet end of the at least one connector pipe, the spray bar having a plurality of nozzles adapted to produce a plurality of water streams projected toward a bathing position;
a second flow control valve disposed between the at least one connector pipe and the spray bar;
at least one mounting device for affixing the spray bar on or adjacent a vertical surface near the bathing position, the mounting device comprising a clamp adapted for receiving an outer diameter of the spray bar and an fastening means.

19. The assembly according to claim 18, wherein the fastening means comprises a suction cup or an adhesive.

20. The assembly according to claim 18, wherein the at least one connector pipe comprises a first connector pipe and a second connector pipe and wherein the at least one swivel joint comprises a first swivel joint disposed between the second outlet of the 3-way connector and the first connector pipe, a second swivel joint disposed between the first connector pipe and the second connector pipe, and a third swivel joint disposed between the second connector pipe and the spray bar.
